(19) United States
(12) Patent Application Publication
(10) Pub. No.: US 2007/0113552 A1
(43) Pub. Date: May 24, 2007

(54) Turbocharger

(76) Inventors: John K. Fremerey, Bonn (DE); Hermann Stelzer, Aachen (DE); Jens-Wolf Jaisle, Stuttgart (DE)

Correspondence Address: CLARK & BRODY, 1090 VERMONT AVENUE, NW, SUITE 250, WASHINGTON, DC, 20005, US

(21) Appl. No.: 11/652,572

(22) Filed: Jan. 12, 2007

Related U.S. Application Data
(62) Division of application No. 11/130,158, filed on May 17, 2005.

(30) Foreign Application Priority Data
May 18, 2004 (DE) 102004025049.9-13

(51) Int. Cl. F02B 33/44

(52) U.S. Cl. 60/605.1; 60/598

(57) ABSTRACT

A turbocharger comprises a shaft connecting a turbine wheel, which is disposed in a turbine housing, to an impeller wheel. Between the two is a bearing system having a bearing housing and bearings for the shaft disposed therein. The shaft is fitted with at least one heat insulation between the turbine wheel and the bearing system, of which the heat conductivity is lower than that of the portions of the shaft which are adjoining said insulation and which hampers heat transmission through the shaft.

### CROSS REFERENCE TO RELATED APPLICATIONS

This is a divisional of U.S. application Ser. No. 11/130,158 filed May 17, 2005.

### FIELD OF INVENTION

The present invention relates to an exhaust-gas driven turbo supercharger, hereafter turbocharger, comprising a shaft connecting a turbine wheel mounted in a turbine housing to an impeller wheel, further an in-between bearing system fitted with a bearing housing and enclosing shaft bearings.

### BACKGROUND OF THE INVENTION

Turbochargers improve efficiency and hence the output of internal combustion engines. They comprise a shaft which at one end is fitted with a turbine wheel and at the other end with an impeller wheel. The turbine wheel is loaded by a flow of exhaust air from the internal combustion engine and basically the exhaust gas' heat energy is thereby converted by the turbine wheel into rotation. The impeller is driven by the shaft and draws in fresh air which flows at higher pressure into the internal combustion engine's intake ducts, the rate of filling being improved in this manner.

The bearing system of turbocharger shafts must meet high requirements. On one hand this shaft is subjected to high angular speeds up to 300,000 rpm. On the other hand the turbocharger is exposed by the gas exhaust flow at the turbine side to high temperatures which, in spark-ignition engines, may exceed even 1,000° C. whereas the temperature at the compressor side in general is no more than 150° C. It is clear therefore that the bearings on the turbine side are subjected to enormous thermal stresses.

As regards gliding or ball bearings, temperatures of this magnitude foremost endanger the oil circulation. When critical temperatures are exceeded, oil residues in the form of carbon deposits will form, which in fairly short time, on account of shaft seizure, entail turbocharger failure. The state of the art of spark engines equips the bearing system housing with a jacket of cooling water to keep the bearing housing temperature within appropriate limits. However this feature renders the turbocharger more expensive.

Proposals have been made recently to replace the bearings used to date, namely glide or roller bearings, with magnetic bearings, and in this manner to guide the shaft in contactless manner (see for instance the German patent document DE 102 16 447 C1). Said magnetic bearings offer the advantage they can be operate without lubricants and that as a result the above cause of failure is eliminated. On the other hand the permanent magnets used for such purposes irreversibly lose their magnetic properties when heated to high temperatures.

### BRIEF SUMMARY OF THE INVENTION

Therefore it is the objective of the present invention to design a turbocharger of the initially cited kind in a manner that, using economical steps, heating of the bearings to a temperature degrading their operational reliability shall be averted.

This problem is solved by the present invention in that the shaft between the turbine wheel and the bearing system shall be fitted with at least one heat insulation of which the thermal conductivity is less than that of the shat regions adjoining said insulation and which hampers heat from being transmitted through the shaft. This design feature is based on the insight that a substantial part of the heat generated at the turbine side is transmitted through the shaft into the bearing system. On account of said heat insulation, heat transfer to the bearing system is lowered by appropriately selecting the thermal insulation and its dimensioning to meet the particular requirements.

In the present invention, the heat insulation includes an insulating layer at the shaft cross-section, this layer exhibiting a lower thermal conductivity than the shaft material per se. This insulating layer must be able to withstand the peak temperatures and moreover the shaft may not be unduly weakened mechanically. Metals of adequate mechanical strength and of a certain thermal conductivity, which is lower, especially considerably lower, than that of the remaining shaft portion, are especially suitable. Foremost nickel-chromium alloys are applicable as insulating layers, for instance those known by their tradenames INCONEL and INCOLOY, though high grade steel alloys also are suitable.

Instead of or in combination with an insulating layer, the heat insulation also may comprise a zone of reduced cross-sectional shaft area in order to hamper in this manner the transfer of heat. This design illustratively may be implemented by fashioning a cavity into the shaft, where said cavity moreover may run over the full shaft length, in other words the shaft shall be hollow.

Alternatively to or in combination with the above cited design modes, the problem of the present invention also may be solved by fitting the shaft between the turbine wheel and the bearing system and/or the bearing housing with additional heat transfer surfaces. These additional heat transfer surfaces improve heat dissipation into the ambience. Said heat transfer surfaces for instance may be in the form of at least one cooling disk mounted on the shaft.

Alternatively to or in combination with the above cited design modes, the problem of the present invention also may be solved in that the flanges connecting the bearing housing and the turbine housing are fitted with a thermal insulation of lesser thermal conductivity than the flanges' per se. In this manner the heat conduction entailed through the housings may be reduced.

The simplest way to carry out the design mode just above is to include in said thermal insulation such an insulating layer that it is less thermally conductive than the flange material is per se, said layer being mounted between the flanges. Just as for the case of the shaft's heat insulation, the insulating layer may be a metal, for instance a nickel-chromium alloy or a high grade steel alloy. However other poorly thermally conducting materials, for instance minerals or ceramics, also may be used.

The thermal insulation may comprise insulating ridges instead of or in combination with an insulating layer whereby the flanges abut each other in the flange connection. This design is based on the concept of minimizing the surfaces by which the flange contact one another. The insulating ridges may be designed in a manner to enclose a cavity optionally filled with an insulating material.

Another feature in solving the problem of the present invention provides an external coating at least partly covering the turbine housing and/or the bearing housing to improve heat dissipation into the ambience. This feature also may be combined with the above described implementing mode to enhance bearing protection against thermal stresses. Said coating's heat conductivity may be higher than that of the material constituting the turbine or bearing housing respectively. Illustratively the surface may be aluminum coated by flame spraying. Alternatively or in combination, the said coating should be more emissive than the material of the turbine/bearing housings.

A last step of the present invention consists in coating at least partly the inside of the turbine housing to decrease thereby the heat absorbed by it. The coating's heat absorptivity should be less than that of the turbine housing's material. This feature reduces the housing's heat absorption.

### BRIEF DESCRIPTION OF THE DRAWINGS

The present invention is elucidated by illustrative embodiments schematically shown in the drawing.

FIG. 1 is a longitudinal section of a turbocharger,

FIG. 2 is a detail of the turbocharger shaft of FIG. 1 in sideview,
FIG. 3 is another detail in sideview of a shaft detail of the turbocharger of FIG. 1,

FIG. 4 is a longitudinal section of a housing portion of the turbocharger of FIG. 1,

FIG. 5 is a detail in longitudinal section of the housing portion of FIG. 4,
FIG. 6 is a further detail in longitudinal section of the housing portion of FIG. 4, and
FIG. 7 is a sideview of a turbine wheel and of an impeller wheel which are connected by a shaft for the turbocharger of FIG. 1.

### DETAILED DESCRIPTION OF THE INVENTION

The design of the turbocharger 1 shown in FIG. 1 is conventional. It comprises a shaft 2 on which are affixed a turbine wheel 3 on the right side and an impeller wheel 4 on the left side. In this case the shaft 2 rests by means of omitted bearings in a tubular bearing housing 5. The bearings may be magnetic such as those illustratively shown in the German patent document DE 102 16 447 C1.

The turbine wheel 3 is enclosed by a turbine housing 6 comprising an omitted radial intake aperture. The impeller wheel 4 is enclosed by a compressor housing 9 with a central intake aperture 10. Because of the rotation of the impeller wheel 4, air is sucked into this intake aperture and deflected into the annular space 11. Thereupon this compressed air exits the annular space 11 through an outlet not shown in further detail here and in the direction of the intake to the internal combustion engine.

The turbine housing 6 and the impeller housing 9 are connected by pairs of flanges 12, 13 respectively 14, 15. The flanges 12, 13 respectively 14, 15 are conventionally tightened to each other by omitted screws.

FIG. 2 shows a detail of the shaft near the turbine housing 5 respectively the turbine wheel 3. A spacer 16 made of a nickel-chromium alloy, and therefore being of much lower thermal conductivity than the shaft 2 per se made of steel, is welded into this shaft. The spacer 16 acts as an insulating layer and hampers conductive heat transfer toward the turbine wheel 3 and hence to the bearings in the bearing housing 5.

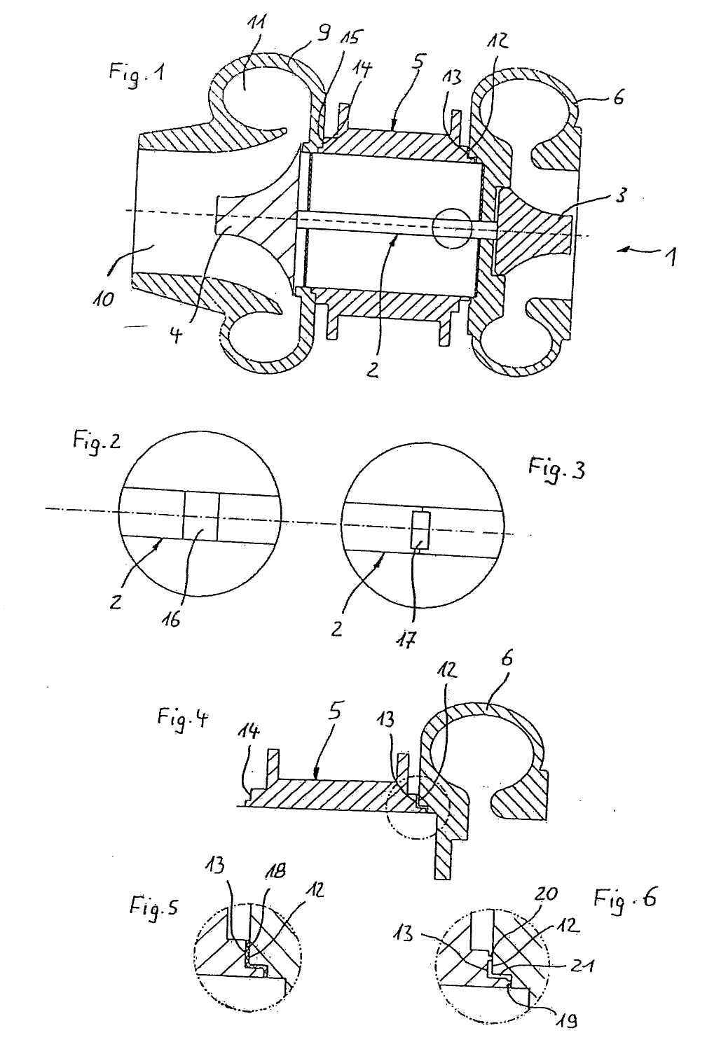

FIG. 3 shows another embodiment mode of a shaft detail mounted at the same place. In this case the shaft 2 is fitted with a cavity 17 which reduces the cross-sectional area of the shaft 2 available for heat conduction to an outer annular zone and thereby hampers heat transmission.

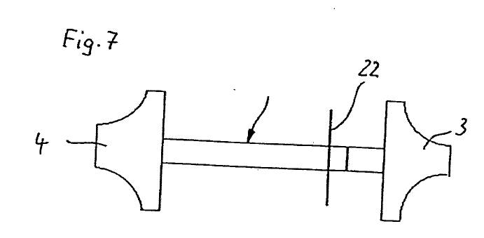

FIG. 4 shows the upper part of the bearing housing 5 and of the adjoining turbine housing 6 in the absence of the shaft 2 and of the turbine wheel 3. FIG. 5 shows a detail, namely a variation of the flange connection between the bearing housing 5 and the turbine housing 6. An insulating layer 18 is configured between the two flanges 12, 13 and reduces the heat transfer from the turbine housing 6 to the bearing housing 5.

The heat transfer between the flanges 12, 13 also may be hampered in that the mutual, abutting contact of the flanges 12, 13 takes place only at ridges 19, 20 as shown in detail in FIG. 6. The ridges 19, 20 run annularly over the full circumference of the flanges 12, 13 and therefore enclose a cavity 21. The small cross-sections of the ridges 19, 20 hamper heat conduction from the flange 12, which is part of the turbine housing 6, to the flange 13 which belongs to the bearing housing 5.

FIG. 7 shows the shaft 2 together with the turbine wheel 3 and the impeller wheel 4 in the absence of any housing. A cooling disk 22 is affixed to and rotates jointly with the shaft 2. The cooling disk enlarges the heat transfer surface to the ambience and by its rotation assures a convection flow enhancing heat dissipation.

Moreover the turbine housing 6 may comprise an external coating at one of its sides such that its heat transfer to the ambience shall be improved, in other words, said coating exhibits higher thermal conductivity and/or higher thermal emittivity than the material of the turbine housing 6. Also the turbine housing 6 may be fitted at its inside with a coating reducing heat absorption.

1-9. (canceled)

10. Turbocharger fitted with a shaft connecting a turbine wheel received in a turbine housing and an impeller wheel with an in-between bearing system having a bearing housing receiving bearings for the shaft, the bearing housing and the turbine housing being connected to each other by flanges, characterized in that the flanges are fitted with a thermal insulation of which the thermal conductivity is less than that of the flanges per se.

11. Turbocharger as claimed in claim 10, characterized in that the thermal insulation includes an insulating layer of which the thermal conductivity is less than that of the material of flanges.

12. Turbocharger as claimed in claim 11, characterized in that the insulating layer is made of a metal.

13. Turbocharger as claimed in claim 12, characterized in that the metal is a nickel chromium alloy or a high grade steel alloy.

14. Turbocharger as claimed in claim 10, characterized in that thermal insulation comprises insulating ridges by means of which the flanges of the flange connection abut each other.

15. Turbocharger as claimed in claim 14, characterized in that the insulating ridges enclose at least one cavity.

16-20. (canceled)

21. Turbocharger as claimed in claim 11, characterized in that thermal insulation comprises insulating ridges by means of which the flanges of the flange connection abut each other.

22. Turbocharger as claimed in claim 12, characterized in that thermal insulation comprises insulating ridges by means of which the flanges of the flange connection abut each other.

23. Turbocharger as claimed in claim 13, characterized in that thermal insulation comprises insulating ridges by means of which the flanges of the flange connection abut each other.
